(19) United States
(12) Patent Application Publication
(10) Pub. No.: US 2019/0132437 A1
(43) Pub. Date: May 2, 2019

(54) TIME DELAYED MESSAGING SYSTEM

(71) Applicant: Harrison R. Fenoglio, New Lenox, IL (US)

(72) Inventor: Harrison R. Fenoglio, New Lenox, IL (US)

(21) Appl. No.: 16/175,292

(22) Filed: Oct. 30, 2018

Related U.S. Application Data
(60) Provisional application No. 62/578,871, filed on Oct. 30, 2017.

(51) Int. Cl. H04M 1/725; H04W 4/12

(52) U.S. Cl. CPC H04M 1/72547; H04W 4/12

(57) ABSTRACT

Method and apparatus are disclosed for time delayed messaging system. An example method to send messages includes receiving, via a touch screen of a mobile device, content of a message to send to a recipient and scheduling, via the touch screen, a time at which to send the message. In the example method, the scheduled time is after a current time. The example method also include storing, in memory of the mobile device, the message associated with the scheduled time. Additionally the example method includes providing, via the touch screen, an opportunity to edit the message before the scheduled time, and sending, via a processor of the mobile device, the message at the scheduled time.

### TECHNICAL FIELD

The present disclosure generally relates to messaging systems on mobile devices and, more specifically, a time delayed messaging system.

### BACKGROUND

Mobile computing devices, such as smartphone and smartwatches, are evolving rapidly. Messaging to and from these devices is more and more becoming the preferred method of communicating. People use mobile computing device message for interpersonal communication. However, organizations, such as businesses and political organizations also rely on it to send notifications to people. One such type of messaging system is short message service (SMS), often referred to as “text messaging” because it was original limited to sending relatively short message that only contained text.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are disclosed for time delayed messaging system. An example method to send messages includes receiving, via a touch screen of a mobile device, content of a message to send to a recipient and scheduling, via the touch screen, a time at which to send the message. In the example method, the scheduled time is after a current time. The example method also include storing, in memory of the mobile device, the message associated with the scheduled time. Additionally the example method includes providing, via the touch screen, an opportunity to edit the message before the scheduled time, and sending, via a processor of the mobile device, the message at the scheduled time.

An example mobile device includes a processor coupled to memory. The processor executes an application stored in the memory to cause the mobile device to receive, via a first interface on a touch screen of the mobile device, content of a message to send to a recipient. Additionally, the application causes the mobile device to schedule, via a second interface on the touch screen, to receive a time at which to send the message, the scheduled time being after a current time. The application also causes the mobile device to store, in the memory of the mobile device, the message associated with the scheduled time, and provide, via the first interface on the touch screen, an opportunity to edit the message before the scheduled time. At the scheduled time, the application causes the mobile device to transmit, via a mobile communication network radio of the mobile device, the message.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIGS. 1A, 1B, and 1C illustrate an application executing on a mobile device to delay transmission of messages.

FIG. 2 is a block diagram of electronic components of the mobile device of FIGS. 1A, 1B, and 1C.

FIG. 3 is a flowchart of a method to delay transmission of message, which may be implemented by the electronic components of FIG. 2.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Text messaging applications facilitate communicating to others one mobile devices through various messaging protocols, such as Short Message Service (SMS). However, the SMS protocol is limited. The SMS protocol provides a standardized method of transmitting, routing, and delivering SMS message on a telephonic network. Despite its technical limitations, one of the reasons SMS messaging endures is because it is transmitted on the telephonic network and messaging does not require a data network connection (e.g., 3G, LTE, etc.). However, barebones features of SMS need to be supplemented to expand its capabilities to reflect the technical needs of users of modern mobile devices. For example, SMS messaging is done instantly (or near instantly), or as soon as a user sends the message. However, users don't always think to messages when it is appropriate to send such messages. For example, a user may remember a siblings birthday a few days before the birthday but may forget to send a message on the day of the birthday. Existing methods of working around this involve setting a reminder in another program, such as a calendar. It is burdensome to enter a reminder in one application, receive the notification of the reminder, open a different application, and send message. For example, the notification may not be noticed or the initial motivation to send the message may be decreased at a later date. Even if the user composes the message to be sent at the later date as part of the calendar reminder, manipulating text on the relatively small touch interface of a mobile device to copy and paste that message into another application is challenging and often frustrating.

As discussed below, an application executing on a mobile device provides for a method of scheduling deliver of messages. The application provides a graphical user interface (GUI) to enable a user to interact with the application. The mobile device executing the application displays the GUI to provide a highly intuitive, user-friendly interface to facilitate a user scheduling a message to send after a specified delay. The delay may be a specific delay of the particular message. For example, a message with the contents of “Happy Birthday” may be scheduled to be sent on October 16 at 12:00 PM. In some examples, the scheduled time and/or day take into account the recipient's time zone. For example, a user in the eastern time zone may schedule a message be send to a recipient in the pacific time zone at 12:00 PM without personally knowing which time zone the recipient is in. In such an example, when the user schedules the delivery of a message for 12:00 PM in the recipient's time zone, the message may be sent at 3:00 PM in the user's time zone. Alternatively or additionally, in some examples, the delay may be based on a global user-define time delay that is applied to all message sent through the application. For example, the user may set that all messages are sent with a five minute delay after being composed. Additionally or alternatively, in some examples, the user may set a messaging blackout period during which messages will not be sent until the blackout period has expired. In some such examples, the blackout period accounts for the time zone of the recipient. For example, the user may specify that messages should not be sent between 11:00 PM and 6:00 AM in the recipient's time zone. In such an example, a message sent by a user in Chicago at 2:00 PM to a recipient in Tokyo may be delayed until 4:00 PM central time (that is, 6:00 AM in GMT +9). During these delay periods, the messages are editable and/or cancelable. In such a manner, the method provides a user with the example benefits of (i) composing messages when the user remembers, even when the message is not yet timely, (ii) preventing messages being delivered at inappropriate times, and/or (iii) allowing a user to cancel or edit messages that were, for example, drafted in a heated moment.

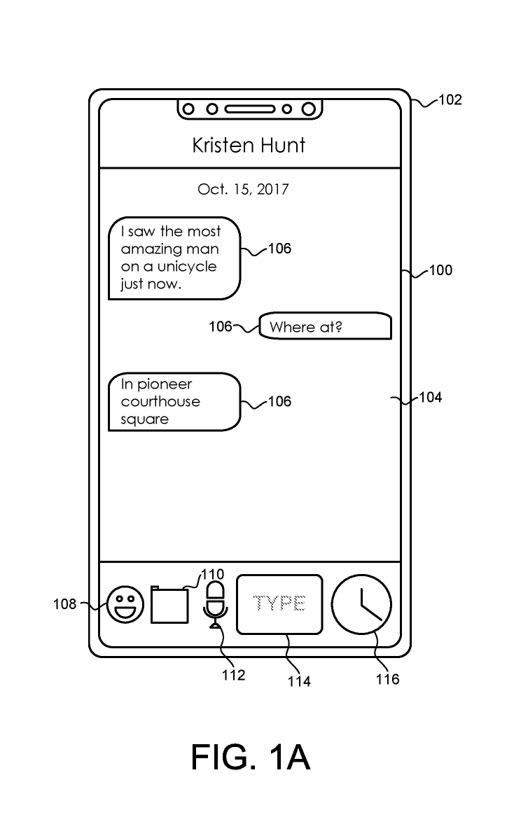

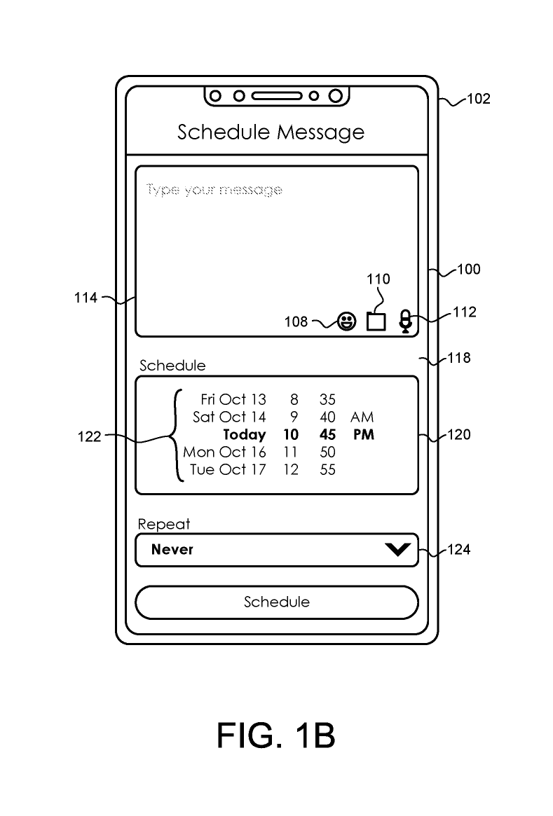

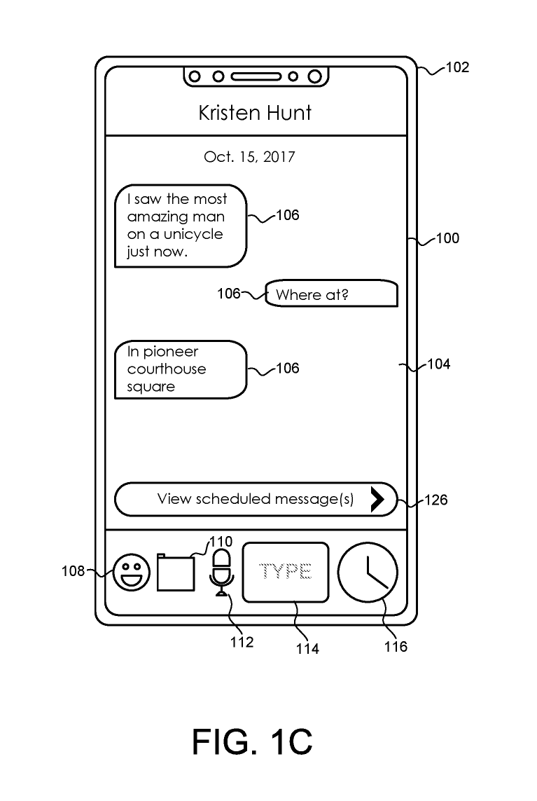

FIGS. 1A, 1B, and 1C illustrate an application 100 executing on a mobile device 102 to delay transmission of messages. As discussed below, the application 100 sends messages via the Short Messaging System (SMS) protocol. However, the application 100 may use any and/or more than one one-to-one messaging protocol. The application 100 includes interfaces to facilitate managing messages to recipients. The application includes a contact interface (not shown) that provides a selectable list of recipients. In some examples, the contact interface also includes a summary of interactions with the recipients on the list of recipients (e.g., the most recent received/sent message, etc.). In the illustrated example of FIG. 1A, the application 100 provides a messaging interface 104 that displays messages 106 between a user and a recipient. The messaging interface 104 includes selectable controls 108, 110, 112, 114, and 116 that facilitate the user entering messages 106 to be send to the recipient. An emoji control 108 provides a list of emojis and/or other pictographs (e.g., a gif, an animated gif, etc.) be inserted into a message to be sent. A file control 110 facilitates inserting a picture stored on the mobile device 102 into the message to be sent. The voice control 112 provides an interface to enter the message to be sent via voice-to-text transcription. The text control 114 provides a textbox in which to enter text through a keyboard (e.g., a hardware keyboard, a soft keyboard, etc.) into the message to be sent. The scheduler control 116 provides a scheduling interface 118 that facilitates scheduling the message to be sent.

FIG. 1B illustrates the scheduling interface 118. The scheduling interface 118 facilitates the user entering and/or scheduling the message to be sent. In the illustrated example, the scheduling interface 118 includes the controls 108, 110, 112, 114, and 116 that facilitate the user entering messages 106 to be send to the recipient. In some examples, when the application 100 transitions to the scheduling interface 118, any information (e.g., text, pictures, emojis, etc.) entered via the controls 108, 110, 112, 114, and 116 on the messaging interface 104 of FIG. 1A are copied into the text control 114 of the scheduling interface 118. Additionally, the scheduling interface 118 includes a scheduler control 120 that facilitates entering information regarding a future time of delivery. In the illustrated example, the scheduler control 120 includes date and time information 122 wherein the user selects (e.g., by individually scrolling through each element of the information) a date and time for the message to be delivered. Alternatively or additionally, in some examples, the scheduler control 120 includes time selections to facilitate the user selecting an amount of time for the application 100 to delay sending the message. Alternatively, in some examples, the scheduling interface 118 does not include the scheduler control 120. Rather, the application 100 sends the messages based on globally set preferences for time delays and blackout periods. In the illustrated example, the scheduling interface 118 includes a repeat control 124. The repeat control 124 facilitates the user entering a period in which to resent the message. For example, the repeat control 124 may include options to repeat the message every day, every week, every month, every year, every specific day of the week, and/or every occurrence of an event (e.g., the phone restarting, the phone proximate a particular set of global positioning system (GPS) coordinates, etc.) etc. For example, the user may schedule the message “Happy Birthday!” to be sent every year on October 16.

FIG. 1C illustrates the messaging interface 104 that includes a scheduled message control 126 while a message has been scheduled but has not yet been sent. When selected, the scheduled message control 126 displays the pending scheduled message(s) and provides information (e.g., contents of the message, scheduled timed time to send, time until the message is sent, etc.) regarding the pending scheduled message(s) and an option to edit the pending scheduled message(s) via the scheduling interface 118.

When a message is scheduled via the scheduling interface 118, the application 100 determines when to send the message. The actual time at which to send the message is based on (i) the scheduled time to send, (ii) the time zone of the recipient, (iii) any time delay preference, and/or (iv) any blackout preference, etc. For example, a message scheduled for delivery at 6:00 PM in the time zone of the recipient may be actually scheduled for delivery at 1:00 PM in the time zone of the user. As another example, a message entered into the application without any particular time scheduled may be delayed by the global delay preference. In some examples, the application 100 may apply more than one timing condition on when the send the message. For example, the application 100 may apply the global blackout preference to a message scheduled for a particular time.

In some examples, the application 100 determines the time zone of the recipient. In some such examples, the application requests that the user enter the time zone of the recipient when the recipient is entered into the list of recipients. Alternatively or additionally, the application 100 receives that time zone of the recipient in a message from the recipients (e.g., as part of the messaging protocol). In such examples, the application 100 determines the time zone of the recipient without input from the user. In such examples, when the application 100 receives a message from the recipient, the application 100 stores the time zone in associated with the recipient in memory.

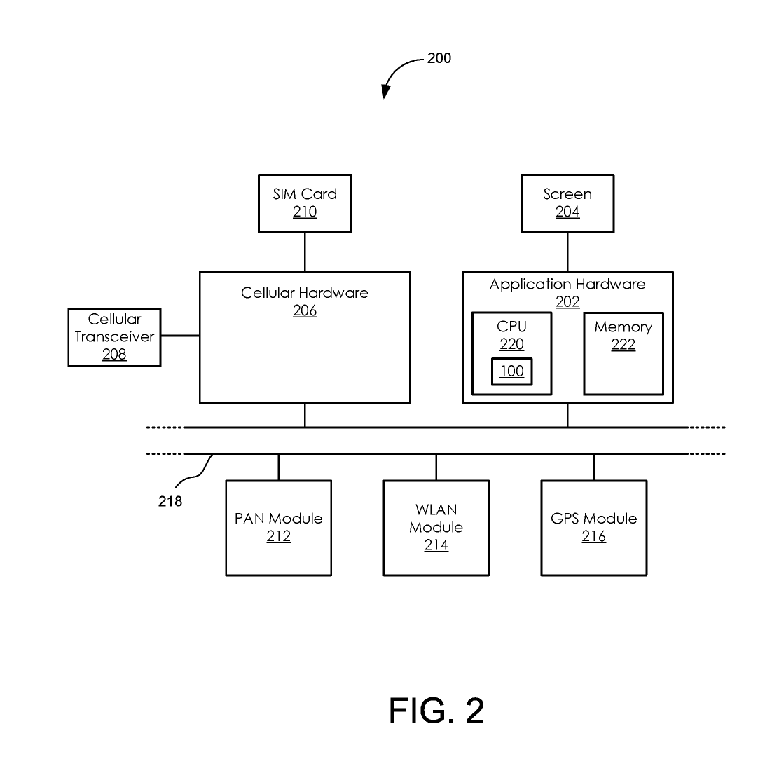

In some examples, when the application 100 creates a time-delayed message, the application 100 appends time-delay attributes to the message data (e.g., the phone number of the recipient, the text of the message, etc.) and stores the appended message data in memory (e.g., the memory 222 of FIG. 2 below). From time-to-time, the application 100 executing in a background mode or a foreground mode, reads the time-delay attributes in memory to determine whether a message is to be sent. In some such examples, the application stores the appended message data in a linear data structure organized by time order to minimize the resources used to search through the memory assigned to the application to determine whether there are message to be sent at a particular time. For example, if the first appended message (or the next appended message) is for a time later than the current time, the application can stop searching the data structure.

FIG. 2 is a block diagram of electronic components 200 of the mobile device 102 of FIGS. 1A, 1B, and 1C. In the illustrated example, the electronic components includes application hardware 202, a screen 204, cellular hardware 206, a cellular transceiver 208, a SIM card 210, a personal area network (PAN) module 212, a wireless local area network (WLAN) module 214, a GPS receiver 216, and a data bus 218.

The application hardware 202 includes a processor or controller 220 and memory 222. In the illustrated example, the application hardware 202 is structured to include application 100. The processor or controller 220 may be any suitable processing device or set of processing devices such as, but not limited to: a microprocessor, a microcontroller-based platform, a suitable integrated circuit, one or more field programmable gate arrays (FPGAs), and/or one or more application-specific integrated circuits (ASICs). The memory 222 may be volatile memory (e.g., RAM, which can include non-volatile RAM, magnetic RAM, ferroelectric RAM, and any other suitable forms); non-volatile memory (e.g., disk memory, FLASH memory, EPROMs, EEPROMs, non-volatile solid-state memory, etc.), unalterable memory (e.g., EPROMs), and/or read-only memory. In some examples, the memory 222 includes multiple kinds of memory, particularly volatile memory and non-volatile memory.

The memory 222 is computer readable media on which one or more sets of instructions, such as the software for operating the methods of the present disclosure can be embedded. The instructions may embody one or more of the methods or logic as described herein. In a particular embodiment, the instructions may reside completely, or at least partially, within any one or more of the memory 222, the computer readable medium, and/or within the processor 220 during execution of the instructions.

The terms “non-transitory computer-readable medium” and “tangible computer-readable medium” should be understood to include a single medium or multiple media, such as a centralized or distributed database, and/or associated caches and servers that store one or more sets of instructions. The terms “non-transitory computer-readable medium” and “tangible computer-readable medium” also include any tangible medium that is capable of storing, encoding or carrying a set of instructions for execution by a processor or that cause a system to perform any one or more of the methods or operations disclosed herein. As used herein, the term “tangible computer readable medium” is expressly defined to include any type of computer readable storage device and/or storage disk and to exclude propagating signals.

The screen 204 receives input from the user(s) and display information. In the illustrated example, the screen 204 is a touch screen. The user interacts with the interfaces 104 and 118, and the controls 108, 110, 112, 114, and 116 via the screen 204. The screen 204 may include a Liquid Crystal Display (LCD), a Thin Film Transistor LCD (TFT-LCD) display, an In Plane Switching LCD (IPS-LCD) display, an Organic Light-Emitting Diode (OLED) display, an Active Matrix OLED (AMOLED) display, or a “Super AMOLED” display, etc.

The cellular hardware 206 includes hardware (e.g., processors, digital signal processing circuitry, memory, etc.) to communicate with a cellular network via the cellular transceiver 208. The cellular hardware 206 handles the cellular protocols (e.g., authentication, signal processing, transmission and reception, etc.). In some examples, the application hardware 202 and the cellular hardware 206 are combined into one hardware package. The cellular hardware 206 uses information stored on the subscriber identity module (SIM) card 210 to communicate with the cellular network, such as an international mobile subscriber identity (IMSI) number and a corresponding authentication key.

The PAN module 212 includes hardware (e.g., processors, memory, storage, antenna, etc.) to communicate with other devices (e.g., a vehicle, a headset, headphones, a smart watch etc.) using a personal area network protocol (e.g., Bluetooth®, Zigbee®, etc.). The WLAN module 214 212 includes hardware (e.g., processors, memory, storage, antenna, etc.) to communicate with external networks (e.g., the Internet, etc.) using a wireless local area network protocol (including IEEE 802.11 a/b/g/n/ac or others). The GPS receiver 216 receives signals from GPS satellites (and, in some example, the cellular network) and calculates the position of the mobile device 102.

The data bus 218 is one or more electrical connections that communicatively couple the application hardware 202, the cellular hardware 206, the PAN module 212, the WLAN module 214 and/or the GPS receiver 216. The data bus(s) 218 may include, for example, Serial Peripheral Interface (SPI) bus(s), Inter-Integrated Circuit (I²C) bus(es), Universal Asynchronous (UART) bus(es), and/or Secure Digital Input/Output (SDIO) bus(es), etc.

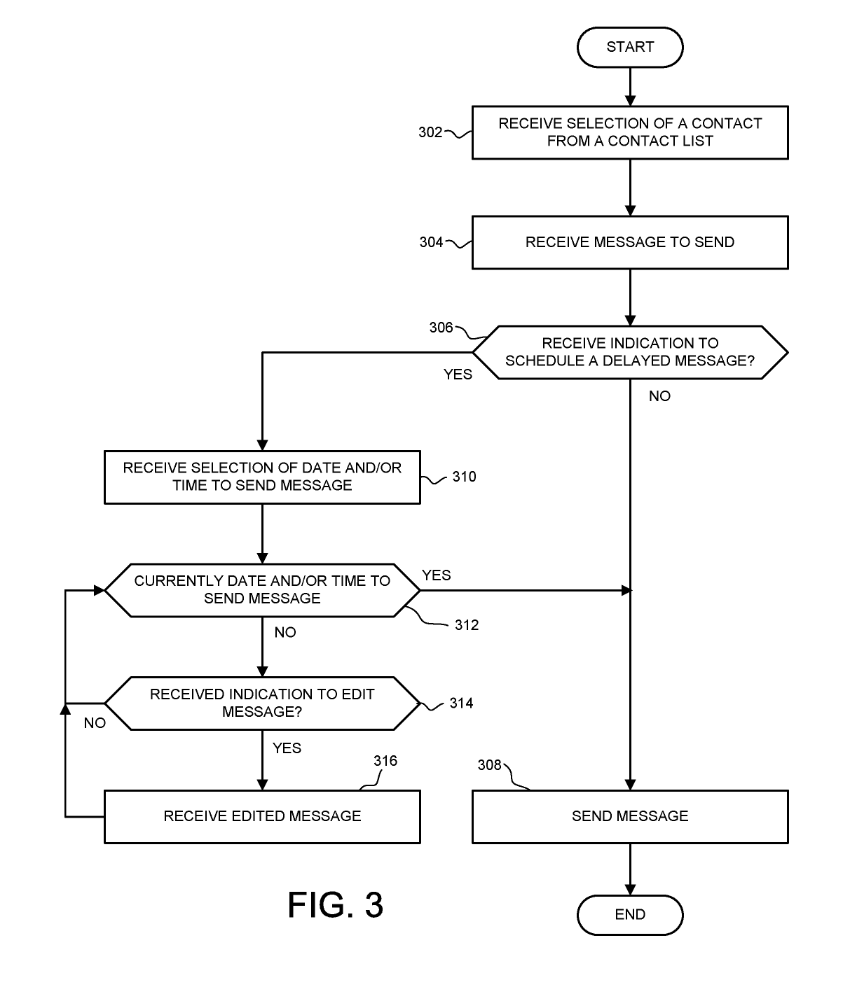

FIG. 3 is a flowchart of a method to delay transmission of message, which may be implemented by the electronic components 200 of FIG. 2. Initially, at block 302, the application 100 receives a selection of a contact from a contact list (e.g., the list of recipients). At block 304, the application 100 receives, via the controls 108, 110, 112, and 114, input of a message (e.g., text, images, emojis, etc.) to send to the contact selected at block 302. At block 306, the application 100 determines whether a indication to schedule a delayed message is received. For example, the user may selected, on the screen 204, the scheduler control 120 to indicate a desire to schedule a delayed message. If the indication to schedule the delayed message is not received, the method continues at block 308. Otherwise, when the indication to schedule the delayed message is received, the method continues at block 310.

At block 308, the application 100 sends the message (e.g., via the cellular hardware 206, via the WLAN module 214, etc.). At block 310, the application receives, via the scheduling interface 118, a selection of a date and/or time at which to send the message received at block 304. At block 312, the application determines whether it is currently the date and/or time to send the message. When it is the date and/or time to send the message, the method continues at block 308. Otherwise, when it is not the date and/or time to send the message, the method continues at block 314. At block 314, the application 100 determines whether it has received an indication to edit the message that is scheduled to be delivered at a later date and/or time. When an indication to edit the scheduled message has be received, the method continues to block 316. Otherwise, when the indication to edit the scheduled message has not been received, the method returns to block 312. At block 316, the application 100 receives edits to the message (e.g., via the controls 108, 110, 112, and 114).

The flowchart of FIG. 3 is representative of machine readable instructions stored in memory (such as the memory 222 of FIG. 2) that comprise one or more programs that, when executed by a processor (such as the processor 220 of FIG. 2), cause the mobile device 102 to implement the example application 100 of FIGS. 1A, 1B, 1C and 2. Further, although the example program(s) is/are described with reference to the flowchart illustrated in FIG. 3, many other methods of implementing the example application 100 may alternatively be used. For example, the order of execution of the blocks may be changed, and/or some of the blocks described may be changed, eliminated, or combined.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A method to send messages, the method comprising:
receiving, via a touch screen of a mobile device, content of a message to send to a recipient;
scheduling, via the touch screen, a time at which to send the message, the scheduled time being after a current time;
storing, in memory of the mobile device, the message associated with the scheduled time;
providing, via the touch screen, an opportunity to edit the message before the scheduled time; and
sending, via a processor of the mobile device, the message at the scheduled time.

2. The method of claim 1, including providing an interface to receive the scheduled time from the user.

3. The method of claim 3, wherein the interface provides elements to receive entry of a specific date and time to define the scheduled time.

4. The method of claim 4, wherein the interface provides elements to receive entry of a delay duration, the delay duration defining an amount of time from the current time.

5. The method of claim 1, including providing an interface to receive a blackout period from the user, the blackout period defining a period of time.

6. The method of claim 5, including when the scheduled time is within the blackout period, automatically changing the scheduled time to be an end time of the blackout period.

7. The method of claim 6, including before determining whether a scheduled time is within the blackout period, modifying the blackout period to account for a difference in time zone between the user and the recipient.

8. The method of claim 1, including modifying the scheduled time to account for a difference in time zone between the user and the recipient.

9. A mobile device comprising:
memory; and
a processor coupled to the memory, the processor to execute an application stored in the memory to cause the mobile device to:
receive, via a first interface on a touch screen of the mobile device, content of a message to send to a recipient;
schedule, via a second interface on the touch screen, to receive a time at which to send the message, the scheduled time being after a current time;
store, in the memory of the mobile device, the message associated with the scheduled time;
provide, via the first interface on the touch screen, an opportunity to edit the message before the scheduled time; and
transmit, via a mobile communication network radio of the mobile device, the message at the scheduled time.

10. The mobile device of claim 9, wherein the time associated with the scheduled time is associated with a first time zone, and wherein the application causes the mobile device to:
without direct user input, determine a second time zone associated with the recipient; and
modify the scheduled time accounting for the difference between the first time zone and the second time zone.

11. The mobile device of claim 9, wherein the application causes the mobile device to receive, via the second interface on the touch screen of the mobile device, a blackout period defining a beginning time and an ending time in which the application is to ignore instructions to send the message.

12. The mobile device of claim 11, wherein the time associated with the scheduled time is associated with a first time zone, and wherein the application causes the mobile device to:
without direct user input, determine a second time zone associated with the recipient; and
at the scheduled time:
determine an adjusted blackout period, the adjusted blackout period being defined by the beginning time and the ending time adjusted to account for the difference between the first time zone and the second time zone; and
when the scheduled time falls within the adjusted blackout period, delay transmitting the message until after the adjusted blackout period.

13. The mobile device of claim 9, wherein to schedule the scheduled time, the application causes the mobile device to receive entry of a delay duration, the delay duration defining an amount of time from the current time.

14. The mobile device of claim 9, wherein to schedule the scheduled time, the application causes the mobile device to receive entry of a specific date and time.

15. A non-transitory computer readable medium storing an application to, when executed by a processor, causes a mobile device to:
receive, via a first interface on a touch screen of the mobile device, content of a message to send to a recipient;
schedule, via a second interface on the touch screen, to receive a time at which to send the message, the scheduled time being after a current time;
store, in the memory of the mobile device, the message associated with the scheduled time;
provide, via the first interface on the touch screen, an opportunity to edit the message before the scheduled time; and
transmit, via a mobile communication network radio of the mobile device, the message at the scheduled time.

16. The computer readable medium of claim 15, wherein the time associated with the scheduled time is associated with a first time zone, and wherein the application causes the mobile device to:
without direct user input, determine a second time zone associated with the recipient; and
modify the scheduled time accounting for the difference between the first time zone and the second time zone.

17. The computer readable medium of claim 15, wherein the application causes the mobile device to receive, via the second interface on the touch screen of the mobile device, a blackout period defining a beginning time and an ending time in which the application is to ignore instructions to send the message.

17. The computer readable medium of claim 17, wherein the time associated with the scheduled time is associated with a first time zone, and wherein the application causes the mobile device to:
without direct user input, determine a second time zone associated with the recipient; and
at the scheduled time:
determine an adjusted blackout period, the adjusted blackout period being defined by the beginning time and the ending time adjusted to account for the difference between the first time zone and the second time zone; and
when the scheduled time falls within the adjusted blackout period, delay transmitting the message until after the adjusted blackout period.

19. The computer readable medium of claim 15, wherein to schedule the scheduled time, the application causes the mobile device to receive entry of a delay duration, the delay duration defining an amount of time from the current time.

20. The computer readable medium of claim 15, wherein to schedule the scheduled time, the application causes the mobile device to receive entry of a specific date and time.
